(19) United States
(12) Patent Application Publication
(10) Pub. No.: US 2026/0119444 A1
(43) Pub. Date: Apr. 30, 2026

(54) Use of PCIExpress to PCIExpress interconnect and Clustering in Data center applications

(71) Applicant: Mammen Thomas, Seattle, WA (US)

(72) Inventor: Mammen Thomas, Seattle, WA (US)

(21) Appl. No.: 19/352,481

(22) Filed: Oct. 8, 2025

Related U.S. Application Data
(63) Continuation of application No. 18/205,515, filed on Jun. 3, 2023.
Application No. 18/205,515 is a continuation of application No. 17/858,083, filed on Jul. 6, 2022, now abandoned.
Application No. 17/858,083 is a continuation of application No. 17/523,878, filed on Nov. 10, 2021, now abandoned.
Application No. 17/523,878 is a continuation of application No. 15/175,800, filed on Jun. 7, 2016, now Pat. No. 11,194,754.
Application No. 15/175,800 is a continuation of application No. 14/588,937, filed on Jan. 3, 2015, now Pat. No. 9,519,608.
(63) Continuation of application No. 13/441,883, filed on Apr. 8, 2012, now abandoned.
Application No. 13/441,883 is a continuation of application No. 11/242,463, filed on Oct. 4, 2005, now Pat. No. 8,189,603.

(51) Int. Cl. G06F 13/42; G06F 13/40; H04L 49/40

(52) U.S. Cl. CPC G06F 13/4282; G06F 13/4022; G06F 13/4221; H04L 49/40; G06F 2213/0026

(57) ABSTRACT

PCI Express (PCIE) is an IO interconnect standard that is developed and implemented as a tree network within Computers and servers for connecting to peripheral devices. Currently PCIE has achieved stability such that PCIE can be used as a basis for other applications. A PCIE based scheme inter-connecting multiple PCIE enabled processing systems as a cluster with at least one PCIE root complex controlling at least a PCIE bus, enabling the scalability of PCIE architecture to be applied for data transport between the connected system. The interconnection uses an outbound port enabled for system interconnection on the PCIE bus of each PCIE enabled computer connecting to one inbound port on an independently programmable network switch having a plurality of inbound ports. The interconnection is using PCIE protocol for data transfer within the cluster to interconnect processors, memory controllers, storage and other network components in Data centers.

### CROSS REFERENCE TO RELATED APPLICATIONS

This application is a continuation-in-part of U.S. application Ser. No. 18/205,515 filed on Jun. 3, 2023 which is pending and which is a continuation of U.S. patent application Ser. No. 17/858,083 filed on Jul. 6, 2022 Titled: “PCI Express to PCI Express based low latency interconnect scheme for clustering systems”, which has been abandoned, which claims priority to U.S. patent application Ser. No. 17/523,878, titled “PCI Express to PCI Express based low latency interconnect scheme for clustering systems” filed on Nov. 10, 2021 which has been abandoned, which claims priority to U.S. patent application Ser. No. 15/175,800 titled “PCI Express. to PCI Express based low latency interconnect scheme for clustering systems” filed on Jun. 7, 2016, which issued as U.S. Pat. No. 11,194,754 od Dec. 7, 2021 which is a continuation of U.S. application Ser. No. 14/588,937 titled “PCI Express to PCI Express based low latency interconnect scheme for clustering systems' filed on Jan. 3, 2015 which issued as a U.S. Pat. No. 9,519,708 on Dec. 13, 2016 is a continuation of U.S. patent application Ser. No. 13/441,883 titled “PCI Express to PCI Express based low latency interconnect scheme for clustering systems” filed on Apr. 8, 2012, currently abandoned, which is a continuation of U.S. patent application Ser. No. 11/242,463 titled “PCI Express to PCI Express based low latency interconnect scheme for clustering systems” filed on Oct. 4, 2005 which issued as U.S. Pat. No. 8,189,603 on May 29, 2012, all of which have a common inventor, and are hereby incorporated by reference for all that

### TECHNICAL FIELD

The invention generally relates to providing high speed interconnect between systems within an interconnected cluster of systems and specifically relates to providing high speed interconnect between PCIE enabled systems within an interconnected cluster in a Data center comprising PCIE enabled systems for enabling High speed data transfer between PCIE enabled systems.

### BACKGROUND AND PRIOR ART

The need for high speed and low latency cluster interconnect scheme for data and information transport between systems have been recognized as a limiting factor to achieving high speed operation in clustered systems and one needing immediate attention to resolve. The growth of interconnected and distributed processing schemes have made it essential that high speed interconnect schemes be defined and established to provide the speeds necessary to take advantage of the high speeds being achieved by data processing systems and enable faster data sharing between interconnected systems. This has become more and more of a need as Data centers handling large amounts of data very fast has become the norm

There are today interconnect schemes that allow data transfer at high speeds, the most common and fast interconnect scheme existing even today is the Ethernet connection allowing transport speeds from 10 MB to as high as 40 GB/sec. TCP/IP protocols used with Ethernet have high over-head with inherent latency that make it unsuitable for some distributed applications. Further TCP/IP protocol tends to drop data packets under high traffic congestion times, which require resend of the lost packets which cause delays in data transfer and is not acceptable for high reliability system operation. Recent developments in optical transport also provide high speed interconnect capability using Ethernet. Efforts are under way in different areas of data transport to reduce the latency of the interconnect as this is a limitation on growth of the distributed computing, control and storage systems. All these require either changes in transmission protocols, re-encapsulation of data or modulation of data into alternate forms with associated delays increase in latencies and associated costs.

### DESCRIPTION OF INVENTION

Peripheral component Interconnect Express (PCIE) or PCI Express® or (PCIe®) as it is known is a standard that has continues to evolve and the standard is handled PCIe standards group (PCIe.Sig.). The current PCIe version is the PCIe.6 with PCIe.7 standard in evolution Servers of today are being challenged to process more intricate and diverse types of workloads in cloud, hybrid-cloud and enterprise data centers (Hybrid Data Centers).

State-of-the-art Generative AI applications require immense computational power supplied by thousands of Graphics Processing Units (GPUs) working in tandem to process complex calculations and massive datasets involved in training Large Language Models (LLMs).

Traditional compute servers must accommodate a diverse set of applications that can be processor, memory, networking, and storage intensive to varying degrees depending on the application use case.

PCIe technology offers many benefits for a diverse set of high-performance servers, including:
1. Scalable connectivity via expansion cards and peripherals such as compute accelerators, network modules, graphics cards, and storage devices in addition to memory via compute express link (CXL)
2. Hot-plug so components can be swapped out while the server is running, minimizing system downtime
3. Multiple PCIe link widths (x1, x2, x4, x8, x16), enabling servers to right-size the connectivity bandwidth link to the solution requirements
4. Backwards compatibility, preserving customer investment and extending equipment longevity

Overall, PCIe technology is a powerful and versatile connectivity interconnect that is essential for the performance and scalability of high-performance servers, and it will continue to play an important role in meeting the demands of new and emerging applications.

PCIE or PCI Express® _(PCIe®) technology has long been an integral part of servers. It was initially used for point-to-point connectivity of network adapters and storage controllers to a single host processor. PCIe technology today has expanded to interconnect many processors to each other, and it has further advanced to connect memory using memory expansion. The PCIe specification continues to evolve its use case as the critical connectivity backbone on which all servers operate.

The PCIE of today has become the backbone of the datacenter infrastructure and connectivity. PCIE is used to enable high-speed, low latency data transfer between clusters of CPU, GPUs, Memory controllers, data storage systems and other network components. Use of PCI interconnect has enabled the network to operate in conjunction with Ethernet with low data loss using data loss control programs such as per flow control (PFC) within the Data centers providing interconnection to a plurality of processors within diverse processing systems, servers memories and storage devices and components that handle intensive work loads due to the artificial intelligence (AI) and large language models (LLM)s. The backwards compatibility and capability to be flexible in connectivity without sacrificing the speed of connectivity and integrity of data within the clusters make it a crucial part and component of the dis-aggregated data centers, including the hybrid data centers comprising cloud-based and on premises infrastructure for providing control and security of data at lower cost, flexibility and scalability

As indicated above PCI Express (PCIE) has achieved a prominent place as the I/O interconnect standard for use inside computers, processing system and embedded systems that allow serial high speed data transfer to and from peripheral devices. The original PCIE provided 2.5-3.8 GB transfer rate per link or lane while the PCIE.6 the current PCIE provides 64 GB/sec/lane using pulse amplitude modulation (PAM4) signaling and fixed size flow control units (FLITs) (the data transfer rates may still change as the standards and data transfer technologies change). The PCIE standard is evolving fast, becoming faster and firm and used within more and more systems. Typically, each PCIE based system has a root complex which controls all connections and data transfers to and from connected peripheral devices through PCIE peripheral end points or peripheral modules. What is disclosed is the use of PCIE standard based peripherals enabled for interconnection to similar PCIE standard based peripheral connected directly using data links, as an interconnect between multiple systems, typically through one or more network switches. This interconnect scheme by using PCIE based protocols for data transfer over direct physical connection links between the PCIE based peripheral devices, (see FIG. 1), without any intermediate conversion of the transmitted data stream to other data transmission protocols or encapsulation of the transmitted data stream within other data transmission protocols, thereby reducing the latencies of communication between the connected PCI based systems within the cluster. The PCIE standard based peripheral enabled for interconnection at a peripheral end point of the system, by directly connecting using PCIE standard based peripheral to PCIE standard based peripheral direct data link connections to the switch, provides for increase in the number of links per connection as bandwidth needs of system interconnections increase and thereby allow scaling of the band width available within any single interconnect or the system of interconnects as required.

FIGS. 3A and 3B, shows an exemplary and non-limiting implementation to show the capability of PCIE for interconnecting the components and network within a Data center 300.

The incoming data stream comes into a switch 301 over ethernet links 301A. The network fabric within the data center is using switches as nodes with ethernet connectivity forming the network fabric 301B within the Data center. These nodes may have PFC based flow control to prevent data loss. The network fabric may contain the AI/LLM scale up fabric switch module 302 which connects to the processing and storage retravel capability needed using the PCIE links for processing the large volume of data necessary for AI and LLM. A large number of processing systems (processors/GPUs) 305-1 to n are interconnected as a cluster 304 using the switch 303 that connects to a port of the switch 301. Any data loss prevention software exist at the ethernet connection port of the network fabric switch. Data gets transferred to and from the switch 302 in PCIE data format to the cluster 304 that is configured as the AI/LLM scale up fabric to process data. The processors 305 within the cluster are connected to Re-timers 306, Memory/Flash controllers 307, Storage arrays 308, accelerators 309 and switches for coupling peripheral and other application specific devices to the cluster 310. The connections within the AI/LLM scale up fabric switch module 302 is using PCIE links and using PCIE protocol. By this scheme of interconnection, a large volume of data processing capability is possible at the AI/LLM scale up fabric switch modules 302 of the Data center, either in on-premises private data center, cloud based data center, or a hybrid data center integrating the two types together. The clusters so formed may be expanded to large size clusters by linking the switch 303 to other such switches as per this application.

### Some Advantages of the Proposed Connection Scheme:

1. Reduced Latency of Data transfer as conversion from PCIE to other protocols are avoided during transfer.
2. The number of links per connection can scale from X1 to larger numbers X32 or even X64 as PCIE capabilities increase to cater to the connection bandwidth needed.
Minimum change in interconnect architecture is needed with increased bandwidth, enabling easy scaling with need.
3. Any speed increase in the link connection due to technology advance is directly applicable to the interconnection scheme.
4. Standardization of the PCIE based peripheral will make components easily available from multiple vendors, making the implementation of interconnect scheme easier and cheaper.
5. The PCIE based peripheral to PCIE based peripheral links in connections allow ease of software control and provide reliable bandwidth.

### BRIEF DESCRIPTION OF FIGURES

FIG. 1 Typical Interconnected (multi-system) cluster (shown with eight systems connected in a star architecture using direct connected data links between PCIE standard based peripheral to PCIE standard based peripheral)

FIG. 2—is a cluster using multiple interconnect modules or switches to interconnect smaller clusters.

FIG. 3A—is a typical connection scheme showing the network Fabric in a data center using PCIE.

FIG. 3B—is a typical and nonlimiting block diagram of the PCIE based clustering interconnection within the AI/LLM scaleup module enabled to handle the high volume of data processing and storage.

### EXPLANATION OF NUMBERING AND LETTERING

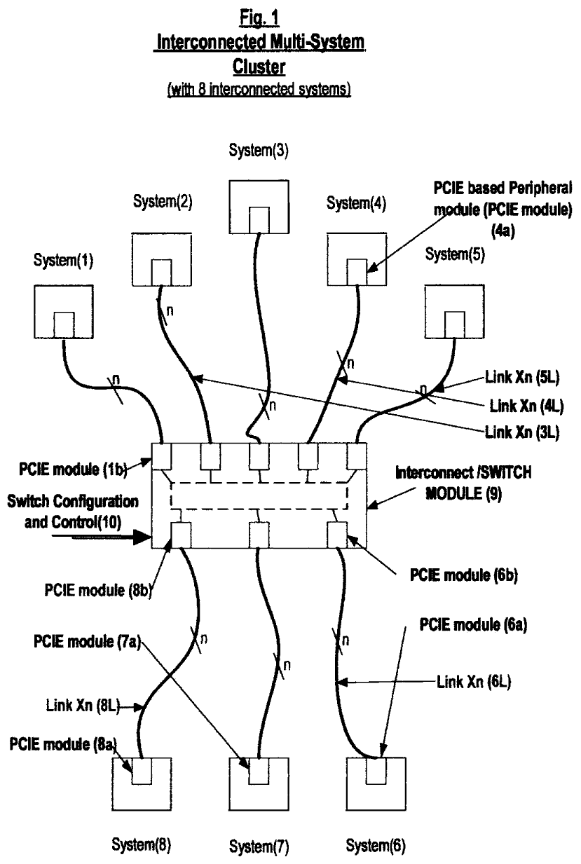

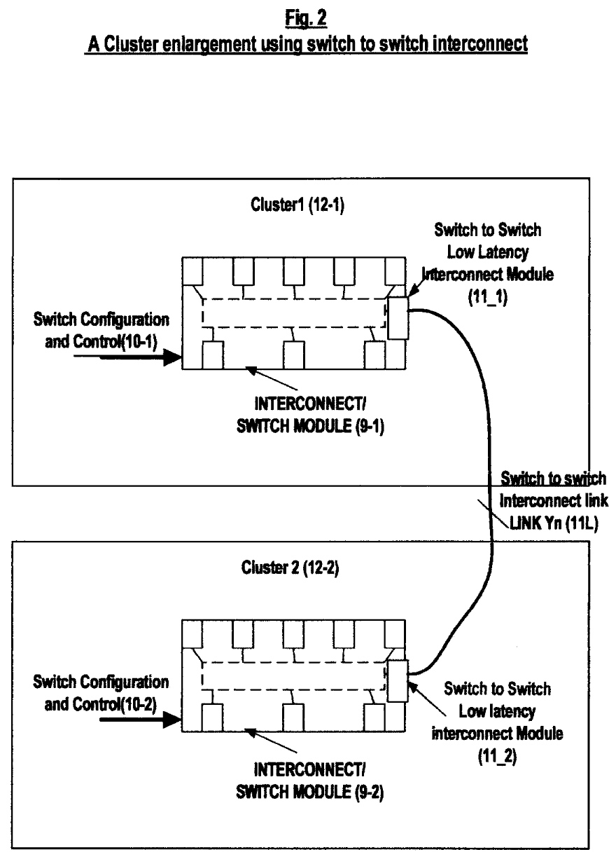

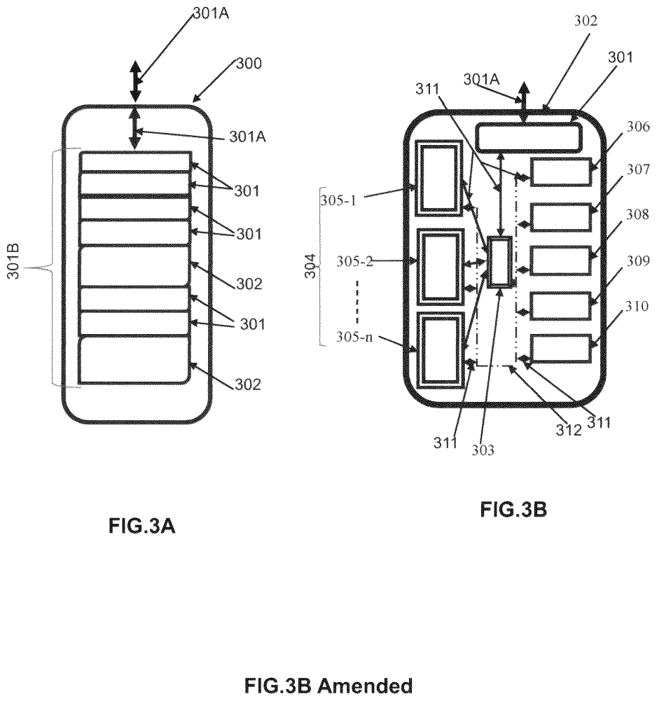

FIG. 1—
(1) to (8): Number of Systems interconnected in FIG. 1
(9): Switch sub-system.
(10): Software configuration and control input for the switch. (1a) to (8a): PCI Express based peripheral module (PCIE Modules) attached to systems.
(1b) to (8b): PCI Express based peripheral modules (PCIE Modules) at switch.
(1L) to (8L): PCIE based peripheral module to PCIE based peripheral module connections having5 n-links (n-data links).
FIG. 2—
(12-1) and (12-2): clusters.
(9-1) and (9-2): interconnect modules or switch sub-systems.
(10-1) and (10-2): Software configuration inputs.
(11-1) and (11-2): Switch to switch interconnect module in the cluster.
(11L): Switch to switch interconnection.
FIG. 3A—
300—Data center with network Fabric
301—Network node switch in data center.
301A—Ethernet Link.
301B—network fabric comprising 301 and 302.
302—AI/LLM scale up fabric switch module in data center.
FIG. 3B—
303—Switch enabled for clustering processing systems and other devices into clusters using PCIE as interconnect technology.
304—Cluster of processing systems (processors and GPUs).
305-1 to 305-n—a Plurality of n processing systems in a cluster.
306—Re-timers coupled to the cluster.
307—Memory or lash controllers coupled to the cluster.
308—Storage arrays coupled to the cluster using PCIE links.
309—Accelerators.
310—Switches for coupling Peripheral devices and other devices for specific application to the cluster.

### Further Description of the Invention (Previously Introduced) for Clustering

PCI Express (PCIE) was developed as an IO interconnect standard that is implemented as a tree network with a root complex connecting to a CPU having one or more processors. The root complex acts as the root node for use inside the computer for connecting to peripheral devices. Currently PCIE has achieved stability such that PCIE can be used as a basis for other applications.

A PCIE based scheme inter-connecting multiple PCIE enabled computer systems each having at least one PCIE root complex controlling at least a PCIE bus, enabling the scalability of PCIE architecture to be applied for data transport between the connected system cluster is proposed. The interconnection uses an outbound port enabled for system interconnection on the PCIE bus of each PCIE enabled computer connecting to one inbound port on an independently programmable network switch having a plurality of inbound ports. The interconnection is using PCIE protocol for data transfer within the cluster.

PCIE is a Bus standard for use inside the computer or embedded system enabling faster data transfers to and from peripheral devices. The standard is still evolving but has achieved a degree of stability such that other applications can be implemented using PCIE as basis. A PCIE based interconnect scheme to enable switching and inter-connection between multiple PCIE enabled systems each having its own PCIE root complex, such that the scalability of PCIE architecture can be applied to enable data transport between connected systems to form a cluster of systems, is proposed. These connected PCIE enabled systems can be any computing, control, storage or embedded systems. The scalability of the interconnect will allow the cluster to grow the bandwidth between the systems as they become necessary without changing to a different connection architecture.

FIG. 1 is a typical cluster interconnect. The Mul@-system cluster shown consist of eight units or systems {(1) to (8)} that are to be interconnected. Each system is PCI Express (PCIE) based system with a PCIE root complex for control of data transfer to and from connected peripheral devices via PCIE peripheral modules as is standard for PCIE based systems. Each system to be interconnected has at least a PCIE based peripheral module {(1a) to (8a)} as an IO module, at the interconnect port enabled for system interconnection, with n-links built into or attached to the system. (9) is an interconnect module or a switch sub-system, which has number of PCIE based connection modules equal to or more than the number of systems to be interconnected, in this case of FIG. 1 this number being eight {(1b) to (8b)}, that can be interconnected for data transfer through the switch. A software based control input is provided to configure and/or control the operation of the switch and enable connections between 5 the switch ports for transfer of data. Link connections {(1L) to (8L)} a[ach the PCIE based peripheral modules 1a to 8a, enabled for interconnection on the respective systems 1 to 8, to the on the switch with n links. The value of n can vary depending on the connect band width required by the system. When data has to be transferred between say system 1 and system 5, in the simple case, the control is used to establish an internal link between PCIE based peripheral modules 1b and 5b at the respective ports of the switch. A hand-shake is established between outbound communication enabled PCIE based peripheral module (PCIE Module) la and inbound PCIE module 1b at the switch port and outbound PCIE module 5a on the switch port and inbound communication enabled PCIE module 5b. This provides a through connection between the PCIE modules 1a to 5b through the switch allowing data transfer. Data can then be transferred at speed between the modules and hence between systems. In more complex cases data can also be transferred and queued in storage implemented in the switch, at the ports and then when links are free transferred out to the right systems at speed.

Multiple systems can be interconnected at one time to form a multi-system that allow data and information transfer and sharing through the switch. It is also possible to connect smaller clusters together to take advantage of the growth in system volume by using an available connection scheme that interconnects the switches that form a node of the cluster.

If need for higher bandwidth and low latency data transfers between systems increase, the connections can grow by increasing the number of links connecting the PCIE modules between the systems in the cluster and the switch without completely changing the architecture of the interconnect. This scalability is of great importance in retaining flexibility for growth and scaling of the cluster.

It should be understood that the system may consist of peripheral devices, storage devices and processors and any other communication devices. The interconnect is agnostic to the type of device as long as they have a PCIE module at the port to enable the connection to the switch. This feature will reduce the cost of expanding the system by changing the switch interconnect density alone for growth of the multi-system.

PCIE is currently being standardized and that will enable the use of the existing PCIE modules to be used from different vendors to reduce the overall cost of the system. In addition, using a standardized module in the system as well as the switch will allow the cost of software development to be reduced and in the long run use available software to configure and run the systems.

As the expansion of the cluster in terms of number of systems, connected, bandwidth usage and control will all be cost effective, it is expected the overall system cost can be reduced and over all performance improved by standardized PCIE module use with standardized software control. Typical connect operation may be explained with reference to two of the systems, example system (1) and system (5). System (1) has a PCIE module (1a) at the interconnect port and that is connected by the connection link or data-link or link (1L) to a PCIE module (1b) at the IO port of the switch (9). System (5) is similarly connected to the switch trough the PCIE module (5a) at its interconnect port to the PCIE module (5b) at the switch (9) IO port by link (5L). Each PCIE module operates for transfer of data to and from it by standard PCI Express protocols, provided by the configuration software loaded into the PCIE modules and switch. The switch operates by the software control and configuration loaded in through the software configuration input.

FIG. 2 is that of a multi-switch cluster. As the need to interconnect larger number of systems increases, it will be optimum to interconnect multiple switches of the clusters to form a new larger cluster. Such a connection is shown in FIG. 2. The shown connection is for two smaller clusters (12-1 and 12-2) interconnected using PCIE modules that can be connected together using any low latency switch to switch connection (11-10 and 11-2), connected using interconnect links (11L) to provide sufficient band width for the connection. The switch to switch connection transmits and receives data and information using any suitable protocol and the switches provide the interconnection internally through the software configuration loaded into them.

The following are some of the advantages of the disclosed interconnect scheme
1. Provide a low latency interconnect for the cluster.
2. Use of PCI Express based protocols for data and information transfer within the cluster.
3. Ease of growth in bandwidth as the system requirements increase by increasing the number of links within the cluster.
4. Standardized PCIE component use in the cluster reduce initial cost.
5. Lower cost of growth due to standardization of hardware and software.
6. Path of expansion from a small cluster to larger clusters as need grows.
7. Future proofed system architecture.
8. Any speed increase in the link connection due to technology advance is directly applicable to the interconnection scheme.

In-fact the disclosed interconnect scheme provides advantages for low latency multi-system cluster growth that are not available from any other source.

While the invention has been described in terms of several embodiments, those of ordinary skill in the art will recognize that the invention is not limited to the embodiments described, but can be practiced with modification and alteration within the spirit and scope of the appended claims. Multiple existing methods and methods developed using newly developed technology may be used to establish the handshake between systems and to improve data transfer and latency. The description is thus to be regarded as illustrative instead of limiting and capable of using any new technology developments in the field of communication and data transfer. There are numerous other variations to different aspects of the invention described above, which in the interest of conciseness have not been provided in detail. Accordingly, other embodiments are limited only within the scope of the claims.

1. (canceled)

2. A system, the system comprising:
a datacenter network fabric
wherein the data center network fabric comprises a plurality of interconnected network node switches and a plurality of artificial intelligence (AI) with large language models (LLM) that are AI/LLM scale up fabric switch modules;
wherein each of the AI/LLM scale up fabric switch module also comprises a network node switch;
the network node switches within and outside the AI/LLM scale up fabric switch modules are interconnected using Ethernet links forming the data center network fabric;
the network node switch in the AI/LLM scale up fabric switch module is coupled to a PCIE enabled switch; and
the PCIE enabled switch interconnects a plurality of processing systems, comprising processors and Graphics processing units (GPUs), in a cluster to handle a large volume of data for Artificial Intelligence (AI) and large language models (LLM)s.

3. The AI/LLM scale up fabric switch module of claim 2, wherein the network node switch in the AI/LLM scale up fabric switch module is connected to the PCIE enabled switch using PCIE protocol over PCIE links for data transfer.

4. The AI/LLM scale up fabric switch module of claim 2, wherein the AI/LLM scale up fabric switch module further comprises one or more devices from the group comprising re-timers, controllers for memory and memory cache, storage arrays, accelerators and network switches for connecting applications and peripheral devices that are coupled to the plurality of processing systems.

5. The devices of claim 4, wherein the devices coupled to the cluster of processing systems are used for handling the large volume of data for the AIs and LLMs.

6. A system for interconnecting a plurality of processing systems in a cluster with a plurality of other devices coupled to the processing systems within a data center for handling data required by Artificial Intelligence (AI) and Large language Models (LLMs), the system comprising:
a network fabric comprising plurality of network nodes and a plurality of AI/LLM scale up fabric switch modules;
the plurality of network node switches in a network fabric at the nodes of the network and at least a plurality of network node switches in each of the AI/LLM scale up fabric switch module of the data center;
the network node switches at the network nodes and the AI/MLL scale up fabric switch module interconnected using Ethernet links;
the network node switch in the AI/LLM scale up fabric switch module of the data center connecter to a PCI enabled switch in the AI/LLM scale up fabric switch module using PCIE protocol over PCIE links;
the PCIE enabled switch interconnecting the plurality of processing systems in the cluster using PCIE protocol over PCIE links;
a plurality of other devices coupled to one or more of the plurality of processing systems using PCIE based interconnect;
wherein the plurality of processing systems forming a cluster and other devices coupled to the one or more of the processing systems are used to process the volume of data for the AI and LLMs at speed.

7. The system of claim 6, wherein the plurality of other devices coupled to one or more of the plurality of processing systems interconnected in the cluster comprise one or more devices from the group comprising: re-timers, controllers for memory and cache, storage arrays, accelerators and network switches.

8. The system of claim 6, wherein the other devices are coupled to the processing systems to enable the handling of data for AIs and LLMs.

9. The system of claim 6, wherein the clustering using PCIE technology and having the one or more processors coupled to the other devices using PCIE technology enable remote direct memory access (RDMA) within the data center.

10. A system for handling massive data processing requirements of Artificial intelligence (AI) and Large Language Models (LLM)s in a data center with low latency, the system configured to receive a data stream into the data center network over ethernet links;
the data center network fabric comprising network node switches that are Ethernet switches and AI/LLM scale up fabric switch modules that also comprising network switches interconnected within the datacenter network fabric using Ethernet links;
the ethernet connected network node switches enabled to prevent data loss using per flow control (PFC);
the network node switch in the AI/LLM scale up fabric switch module further connect to the PCIE enabled switch over PCIE links using PCIE protocol; and
the PCIE enabled switch configured to connect in a cluster the plurality of processing systems using PCIE protocol over PCIE links.

11. The system of claim 10, wherein the cluster of plurality of processing systems is enabled to handle the massive data processing requirements of AI and LLMs in the data center.
